(19) United States
(12) Patent Application Publication
(10) Pub. No.: US 2016/0378112 A1
(43) Pub. Date: Dec. 29, 2016

(54) AUTONOMOUS VEHICLE SAFETY SYSTEMS AND METHODS

(71) Applicant: INTEL CORPORATION, Santa Clara, CA (US)

(72) Inventors: Igor Ljubuncic, Chiswick (GB); Raphael Sack, Amuka (IL); Tomer Rider, Nahariya (IL); Shahar Taite, Or Akiva (IL)

(21) Appl. No.: 14/752,572

(22) Filed: Jun. 26, 2015

(51) Int. Cl. G05D 1/00; B60Q 5/00; G06K 9/00; B60W 30/16

(52) U.S. Cl. CPC G05D 1/0055; G05D 1/0088; B60W 30/16; B60Q 5/005; G06K 9/00838; G06K 9/00845; G06K 9/00255

(57) ABSTRACT

Autonomous vehicle safety systems and methods are disclosed, which detect and consider occupant reactions to potential hazards to suggest or incorporate safety procedures. Also disclosed are systems for controlling autonomous vehicles based on occupant sentiment and other occupant data in order to improve the occupant driving experience. The disclosed embodiments may include an occupant monitoring system obtaining occupant data for an occupant of the autonomous vehicle. A learning engine can process occupant data received from the occupant monitoring system to identify one or more suggested driving aspects based on the occupant data. A vehicle interface can communicate the one or more suggested driving aspects to the autonomous vehicle, such as a defensive action that can enhance safety of the occupant(s).

### TECHNICAL FIELD

Embodiments described herein generally relate to autonomous vehicles. More particularly, the disclosed embodiments relate to autonomous vehicle safety systems and methods.

### BACKGROUND

Autonomous (self-driving) cars are equipped with numerous safety systems designed to respond accurately to obstacles, problems, and emergency situations. These systems are based on direct input data collected from the surroundings using on board sensors. These presently available safety systems, and this approach of collecting and processing direct input data from the surroundings, are an effective solution and operate effectively for traffic when all vehicles are self-driving. However, these systems and this approach does not sufficiently address a mixed environment with human participants (drivers) who do not necessarily obey or adhere to strict algorithms and rules in the same way as autonomous cars. The autonomous car safety systems presently available cannot predict or anticipate what other human participants in the traffic will do. However, human occupants of a vehicle (e.g., a driver and/or other passengers) can sometimes intuitively analyze a dangerous situation and react before it happens. For example, a human driver of another vehicle may be distracted by talking on his or her phone. From a purely mathematical perspective, there is not a problem, and safety systems of an autonomous car may have not a basis or an ability to detect a problem, but there might be a problem in a matter of only a few seconds. As another example, a human driver of another car may be driving a vehicle to approach a traffic roundabout and, based on speed, direction, focus, or other factors, may appear as if he or she is not going to stop and give the right-of-way to cars entering the roundabout. Again, from a purely mathematical perspective, there may be sufficient time to brake or slow down, but the presently available safety systems of an autonomous car may not have a basis or an ability to detect the other driver's intention through the roundabout.

Autonomous cars also introduce a new driving experience, controlled by a machine rather than a human operator. This change in control may provide an experience that is different from and likely less comfortable to a given occupant, depending on that occupant's driving preferences and/or style. The presently available autonomous controller systems and methods may provide a mechanistic experience determine solely by algorithms based on sensor data input, an experience that does not account for occupant preferences and sentiments concerning driving aspects.

### BRIEF DESCRIPTION OF THE DRAWINGS

FIG. 1A is a side partial cut-away view of a vehicle that includes a system for control based on occupant parameters, according to one embodiment.

FIG. 1B is a top partial cut-away view of the vehicle of FIG. 1A.

FIG. 2 is a schematic diagram of a system for control based on occupant parameters, according to one embodiment.

FIG. 3 is a flow diagram of a method for control of an autonomous vehicle based on occupant parameters, according to one embodiment.

### DETAILED DESCRIPTION OF PREFERRED EMBODIMENTS

Presently available autonomous vehicles perform to rigid standards, adhering strictly to algorithms and rules. Generally, the vehicles detect and respond to external data and do not account for or react to internal passenger behavior in the absence of external sensor data (e.g., that indicates danger).

Many situations are “legally OK” from the traffic data perspective but could very quickly escalate into dangerous situations, such as: drivers turning without putting turn signals on or suddenly veering; drivers distracted when approaching an intersection, junction, or roundabout; a large vehicle (e.g., a truck) approaching at a very high speed; and someone on the shoulder replacing a tire on his or her car and someone else overtaking your car at the exact point where you drive past the parked car and the exposed driver. There are many other similar situations.

The present disclosure provides systems and methods for controlling an autonomous vehicle. The disclosed systems and methods consider occupant parameters, including reactions, sentiments, preferences, patterns, history, context, biometrics, feedback, and the like, to provide suggested driving aspects to or otherwise direct or control driving aspects of the autonomous vehicle to improve safety and/or comfort of an autonomous driving experience.

The disclosed embodiments may include sensors that would track the people inside the vehicle. A single occupant that the embodiments identify as the “human driver” may be tracked, even though that person may not be actively participating in the drive. Alternatively, or in addition, all passengers may be tracked. The disclosed embodiments may monitor certain occupant parameters. When an anomaly in one or many of these parameters is detected, the system may exercise a defensive human-like action, without compromising the built-in safety of the autonomous car. Example actions can include: slowing down while inside the junction or roundabout to avoid a potential collision; in the right-driving countries, pulling over to a shoulder to the right if a human driver sees another car veering from his or her lane and is about to ram into his or her car; slowing down early and signaling with emergency lights if a sudden jam on a high-speed road is detected; slowing down if seeing someone driving recklessly, swerving wildly, etc.; other defense actions that normally include reducing speed and increasing distance.

The disclosed embodiments may include sensors and other sources of information to detect human sentiments concerning driving aspects and provide suggested driving aspects in accordance with those sentiments.

Example embodiments are described below with reference to the accompanying drawings. Many different forms and embodiments are possible without deviating from the spirit and teachings of the invention, and so the disclosure should not be construed as limited to the example embodiments set forth herein. Rather, these example embodiments are provided so that this disclosure will be thorough and complete, and will convey the scope of the invention to those skilled in the art. In the drawings, the sizes and relative sizes of components may be exaggerated for clarity. The terminology used herein is for the purpose of describing particular example embodiments only and is not intended to be limiting. As used herein, the singular forms “a,” “an,” and “the” are intended to include the plural forms as well, unless the context clearly indicates otherwise. It will be further understood that the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise specified, a range of values, when recited, includes both the upper and lower limits of the range, as well as any sub-ranges therebetween.

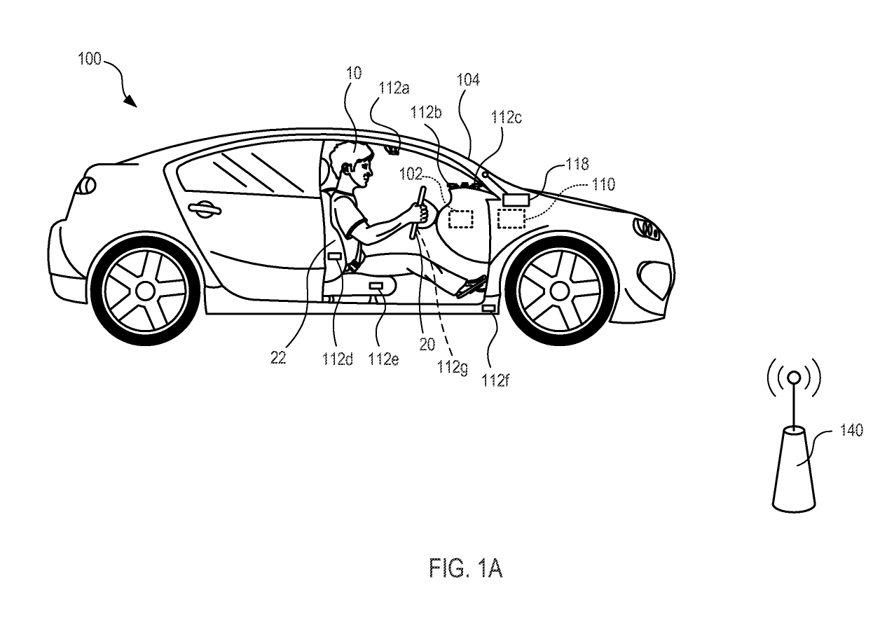

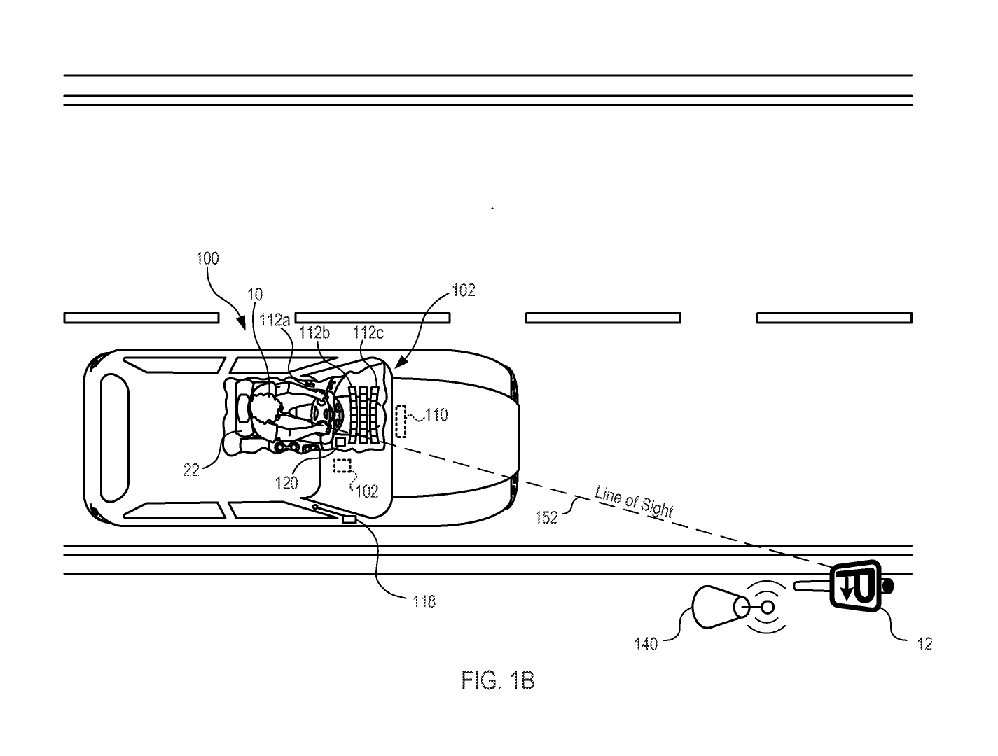

FIGS. 1A and 1B illustrate an autonomous vehicle 100 that includes a system 102 for control based on occupant parameters, according to one embodiment of the present disclosure. Specifically, FIG. 1A is a side partial cut-away view of the vehicle 100. FIG. 1B is a top partial cut-away view of the vehicle 100.

Referring generally and collectively to FIGS. 1A and 1B, the vehicle 100 may be fully autonomous, such that it is able to drive itself to an intended destination without the active intervention of a human operator. The vehicle 100 may be any level of partially autonomous, such that a human operator may monitor and/or control aspects of driving and the vehicle 100 may assume control over aspects of driving (e.g., steering, braking, signaling, acceleration, etc.) at certain times or under certain conditions. The vehicle 100 may use, among other things, artificial intelligence, sensors, or global positioning system coordinates to drive itself or assume control over aspects of driving. The vehicle 100 includes the system 102 for control based on occupant parameters, an autonomous vehicle controller 110, one or more sensors 112a, 112b, 112c, 112d, 112e, 112f, 112g (collectively 112), and a network interface 118. In other embodiments, the system 102 for control based on occupant parameters may comprise one or more of the autonomous vehicle controller 110, the one or more sensors 112, and the network interface 118.

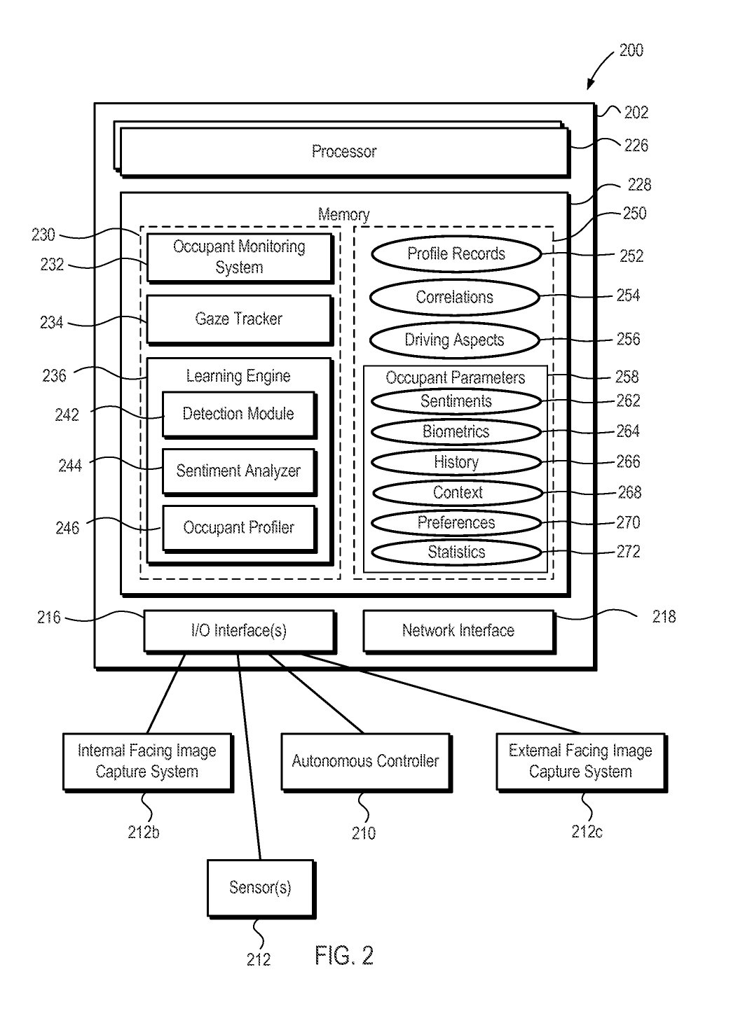

The system 102 for control based on occupant parameters may include an occupant monitoring system to obtain occupant data for an occupant 10 of the autonomous vehicle 100, a learning engine to process the occupant data to identify one or more suggested driving aspects based on the occupant data, and a vehicle interface to communicate the suggested driving aspects to the autonomous vehicle 100. These elements of the system are shown in FIG. 2 and described in greater detail below with reference to the same. The occupant monitoring system may include or otherwise couple to one or more sensors 112.

The one or more sensors 112 may include a microphone 112a, an internal facing image capture system 112b, an external facing image capture system 112c, and one or more pressure sensors 112d, 112e, 112f, 112g. The one or more sensors 112 can detect and/or monitor one or more occupant parameters that may be used by the system 102 for control to identify one or more suggested driving aspects.

For example, the one or more sensors 112 may detect and/or monitor occupant parameters indicative of an occupant reaction to a potential hazard external to the autonomous vehicle 100. The sensors may detect and monitor occupant parameters such as sudden tensing or clenching of muscles, sudden movement of the occupant backwards toward a seat back, twitching of at least one foot or both feet, use of language (or other use of voice such as screaming), eye movement, pupil dilation, head movement, heart rate, breath rhythm, and change in breath intake (e.g., air intake volume), any one or more of which are natural reactions or responses for an occupant who is observing the outside environment and intuitively (e.g., based on experience, discerning a distracted state of a human driver of another vehicle) predicts or anticipates a potential hazardous situation and/or a resulting harm, such as may be caused by a collision. The system 102 for control (e.g., a learning engine) can process sensor data from the one or more sensors 112 of the occupant monitoring system and detect a potential hazard external to the autonomous vehicle 100 based on the one or more occupant parameters. In this manner, the system 102 for control may provide a man-machine interface that enables consideration by the autonomous vehicle 100 and/or the autonomous vehicle controller 110 of occupant parameters.

As another example, the one or more sensors 112 may gather occupant data pertaining to occupant parameters that may be used to detect a sentiment of the occupant 10. The sensors may detect and monitor such occupant parameters as speech, tone of voice, biometrics (e.g., heart rate and blood pressure), occupant image data (e.g., to use in emotion extraction methods), and responses and/or commands (e.g., a feedback mechanism to provide opportunity for the occupant to express likes/dislikes) by voice and/or via a graphical user interface 120 (e.g., a touchscreen).

Some example uses of sensors may include the following. The pressure sensors 112g in a steering wheel 20, the door handle(s), and other occupant handles may detect and monitor occupant parameters such as sudden tensing or clenching of muscles. The pressure sensors 112d, 112e in a seat 22 (e.g., the pressure sensor 112d in the seat back and/or the pressure sensor 112e in the seat base) may detect occupant parameters such as sudden movement of the occupant backwards toward a seat back. A sensor in the floor 112f may detect occupant parameters such as twitching of at least one foot. The microphone 112a may detect occupant parameters such as voice commands, occupant language, occupant use of forms of language, and/or tone of voice. Occupant language and/or forms of language may include commands, phrases, profanity, and other uses of language. Other sensors may detect biometrics such as heart rate and blood pressure.

The internal facing image capture system 112b may detect occupant parameters such as eye movement, pupil dilation, and head movement. More specifically, the internal facing image capture system 112b captures image data of the occupant 10 (or a plurality of occupants) of the vehicle 100. The internal facing image capture system 112b may include an imager or a camera to capture images of the occupant 10. In certain embodiments, the internal facing image capture system 112b may include one or more array cameras. The image data captured by the internal facing image capture system 112b can be used for various purposes. The image data may be used to identify the occupant 10 for obtaining information about the occupant 10, such as a typical head position, health information, and other contextual information. Alternatively, or in addition, the image data may be used to detect a position (e.g., height, depth, lateral distance) of the head/eyes of the occupant 10, which may in turn be used to detect and/or track a current gaze of the occupant 10. The internal facing image capture system 112b may include an eye movement tracker to monitor an eye movement parameter of the occupant 10. The eye movement tracker may include a gaze tracker to process occupant image data of the occupant 10 of the autonomous vehicle 100 to determine a current area of central vision of the occupant 10. The internal facing image capture system 112b may include a pupil monitor to monitor pupil dilation, the pupil monitor comprising a pupil tracker to process occupant image data of the occupant 10 of the vehicle 100 to determine a size of a pupil of the occupant 10. The internal facing image capture system 112b may also provide occupant image data that may be used in emotion extraction methods to identify one or more occupant sentiments.

The external facing image capture system 112c captures image data of an environment in front of the vehicle 100, which may aid in gathering occupant data and/or parameters pertaining to what the occupant 10 may be focusing on. The image data captured by external facing image capture system 112c can be processed in view of gaze tracking and/or line of sight detection to identify where the occupant 10 is focusing attention (e.g., on a driver of another vehicle who may be talking on a cell phone and not paying attention, on a skateboarder who appears about to dart out into traffic). The external facing image capture system 112c may include an imager or a camera to capture images of an area external to the vehicle 100. The external facing image capture system 112c may include multiple imagers at different angles to capture multiple perspectives. The external facing image capture system 112c may also include multiple types of imagers, such as active infrared imagers and visible light spectrum imagers. Generally, the external facing image capture system 112c captures images of an area in front of the vehicle 100, or ahead of the vehicle 100 in a direction of travel of the vehicle 100. In certain embodiments, the external facing image capture system 112c may include one or more array cameras. The image data captured by external facing image capture system 112c may primarily be used by the autonomous vehicle controller 110 for directing and controlling navigation of the autonomous vehicle 100.

With specific reference to FIG. 1B, a line of sight 152 of the occupant 10 may be determined by an eye movement tracker of the internal facing image capture system 112b. Using the line of sight 152 and external image data obtained by the external facing image capture system 112c, the system 102 may determine a focus of attention of an occupant. In FIG. 1B, the line of sight 152 of the occupant 10 is directed toward a sign 12. As can be appreciated, the occupant 10 may in other circumstances be focused on a driver of another vehicle who may not be paying attention or who may be distracted on a mobile phone or other mobile device, or focused on a pedestrian (e.g., small child, walker, jogger, skateboarder, biker, or the like) who may not be paying attention, precariously close darting into traffic, or otherwise into a close vicinity of the autonomous vehicle 100, such as while it is moving.

The system 102 for control may be a safety system for the autonomous vehicle 100 to provide one or more suggested driving aspects that include one or more defensive actions to increase safety of occupants of the autonomous vehicle 100. For example, a human driver of another vehicle may be distracted by talking on his or her phone. The occupant 10 of the autonomous vehicle 100 may look on in apprehension as the other vehicle approaches an intersection more quickly than might be expected. The occupant 10 may tighten his or her hold on a handle or the steering wheel 20 and may brace against the seat 22 for a potential impact. The system 102 receives sensor data for one or more of these occupant parameters and can notify the autonomous vehicle controller 110 of the potential hazard and/or provide suggested defensive action, for example to increase the safety of the occupant 10. Examples of defensive actions that may increase occupant safety include, but are not limited to: decreasing a velocity of travel of the autonomous vehicle 100; signaling and/or activating emergency lights; tightening safety belts; closing windows; locking doors; unlocking doors; increasing distance between the autonomous vehicle 100 and vehicles in a vicinity of the autonomous vehicle 100; alerting authorities; altering the current driving route; altering stopping distance; audibly signaling; and activating one or more emergency sensors configured to detect potential hazards, such that these emergency sensors can provide additional input to the autonomous vehicle controller 110. In this manner, the system 102 for control may provide a man-machine interface that provides a superior additional decision-making vector to a limited set of instructions.

The system 102 for control may also provide one or more suggested driving aspects based on one or more occupant sentiments and/or other occupant data to provide an improved ride for the occupant(s). Stated differently, the system 102 for control may be a system for suggesting driving aspects to the autonomous vehicle 100 and the suggested driving aspects may allow the vehicle 100 to provide an adaptive driving experience by taking into account one or more occupant sentiments, preferences, driving patterns, and/or additional context, thereby aiming for a more personalized and/or customized driving experience. The machine (i.e., the vehicle 100) can more closely drive such that the occupants can expect to experience a drive that is similar to the “steering wheel” (e.g., control of the vehicle 100) being in their hands or as if the “steering wheel” were in their hands. The system 102 may use one or more occupant sentiments, driving history, context, and/or preferences in order to suggest or even control driving aspects such as velocity, acceleration, path (e.g., sharpness of turns, route), and the like to personalize the driving experience and adapt it to the occupant needs and/or preferences. In this manner, the system 102 for control may provide a man-machine interface that provides a superior additional decision-making vector to a limited set of instructions. The system 102 enables the autonomous vehicle 100 to function and operate according to occupant emotions and intentions rather than simply driving in a robot-like manner and feeling.

The network interface 118 is configured to receive occupant data from sources external to and near the vehicle 100. The network interface 118 may be equipped with conventional network connectivity, such as, for example, Ethernet (IEEE 802.3), Token Ring (IEEE 802.5), Fiber Distributed Datalink Interface (FDDI), or Asynchronous Transfer Mode (ATM). Further, the computer may be configured to support a variety of network protocols such as, for example, Internet Protocol (IP), Transfer Control Protocol (TCP), Network File System over UDP/TCP, Server Message Block (SMB), Microsoft® Common Internet File System (CIFS), Hypertext Transfer Protocols (HTTP), Direct Access File System (DAFS), File Transfer Protocol (FTP), Real-Time Publish Subscribe (RTPS), Open Systems Interconnection (OSI) protocols, Simple Mail Transfer Protocol (SMTP), Secure Shell (SSH), Secure Socket Layer (SSL), and so forth.

The network interface 118 may provide an interface to wireless networks and/or other wireless communication devices. For example, the network interface 118 may enable wireless connectivity to wireless sensors (e.g., biometric sensors to obtain occupant heart rate, blood pressure, temperature, etc.), an occupant's mobile phone or handheld device, or a wearable device (e.g., wristband activity tracker, Apple® Watch). As another example, the network interface 118 may form a wireless data connection with a wireless network access point 140 disposed externally to the vehicle 100. The network interface 118 may connect with a wireless network access point 140 coupled to a network, such as a local area network (LAN), a wide area network (WAN), or the Internet. In certain embodiments, the wireless network access point 140 is on or coupled to a geographically localized network that is isolated from the Internet. These wireless connections with other devices and/or networks via the network interface 118 enable obtaining occupant data such as calendar and/or scheduling information from the occupant's calendar. Context data can also be obtained, such as statistics of the driving aspects (e.g., velocity, acceleration, turn radius, travel patterns, routes) of other vehicles through a given sector or geographic area, medical information of the occupant, significant current events (such as may impact mood of an occupant), and other contextual data that may aid in determining suggested driving aspects for the autonomous vehicle 100.

In certain embodiments, the wireless network access point 140 is coupled to a “cloudlet” of a cloud-based distributed computing network. A cloudlet is a computing architectural element that represents a middle tier (e.g., mobile device—cloudlet—cloud). Cloudlets are decentralized and widely dispersed Internet infrastructure whose compute cycles and storage resources can be leveraged by nearby mobile computers. A cloudlet can be viewed as a local “data center” that is designed and configured to bring a cloud-based distributed computing architecture or network closer to a mobile device (e.g., in this case the autonomous vehicle controller 110 or the system 102) and that can provide compute cycles and storage resources to be leveraged by nearby mobile devices. A cloudlet may have only a soft state, meaning it does not have any hard state, but may contain cached state from the cloud. It may also buffer data originating from one or more mobile devices en route to safety in the cloud. A cloudlet may possess sufficient computing power (i.e., CPU, RAM, etc.) to offload resource-intensive computations from one or more mobile devices. The cloudlet may have excellent connectivity to the cloud (typically a wired Internet connection) and generally is not limited by finite battery life (e.g., it is connected to a power outlet). A cloudlet is logically proximate to the associated mobile devices. “Logical proximity” translates to low end-to-end latency and high bandwidth (e.g., one-hop Wi-Fi). Logical proximity may imply physical proximity. A cloudlet is self-managing, requiring little more than power, Internet connectivity, and access control or setup. The simplicity of management may correspond to an appliance model of computing resources, and makes trivial deployment on a business premises such as a coffee shop or a doctor's office. Internally, a cloudlet may be viewed as a cluster of multi-core computers, with gigabit internal connectivity and a high-bandwidth wireless LAN.

In certain embodiments, the wireless network access point 140 is coupled to a fog of a cloud-based distributed computing network. A fog may be more extended than a cloudlet. For example, a fog could provide compute power from ITS (Intelligent Transportation Systems) infrastructure along the road: e.g., uploading/downloading data at a smart intersection. The fog may be contained to peer-to-peer connections along the road (i.e., not transmitting data to the cloud or a remote data center), but would be extended along the entire highway system and the vehicle may engage and disengage in local “fog” computing all along the road. Described differently, a fog may be a distributed, associated network of cloudlets.

As another example, a fog may offer distributed computing through a collection of parking meters, where each individual meter may be an edge of the fog and may establish a peer-to-peer connection with a vehicle. The vehicle may travel through a “fog” of edge computing provided by each parking meter.

In certain other embodiments, the network interface 118 may receive occupant data from a satellite (e.g., global positioning system (GPS) satellite, XM radio satellite). In certain other embodiments, the network interface 118 may receive occupant data from a cell phone tower. As can be appreciated, other appropriate wireless data connections are possible.

FIGS. 1A and 1B illustrate a single occupant, seated in a typical driver position of a vehicle. As can be appreciated, the system 102 may monitor additional or other occupants, such as occupants seated typically where a front passenger and/or rear passengers are seated. Stated otherwise, the autonomous vehicle 100 may not have a steering wheel 20, but rather a mere handle, and thus may not have a driver seat/position. Moreover, the system 102 may monitor a plurality of occupants and may provide suggested driving aspects based on a plurality of occupants (e.g., all the occupants in the vehicle).

FIG. 2 is a schematic diagram of a system 200 for control based on occupant parameters, according to one embodiment. The system 200 includes a processing device 202, an internal facing image capture system 212b, an external facing image capture system 212c, one or more sensors 212 alternative to or in addition to the image capture systems 212b, 212c, and/or an autonomous vehicle controller 210 for controlling navigation and other driving aspects of an autonomous vehicle.

The processing device 202 may be similar or analogous to the system 102 for control based on the occupant parameters of FIGS. 1A and 1B. The processing device may include one or more processors 226, a memory 228, input/output interfaces 216, and a network interface 218.

The memory 228 may include information and instructions necessary to implement various components of the system 200. For example, the memory 228 may contain various modules 230 and program data 250.

As used herein, the word “module,” whether in upper or lower case letters, refers to logic that may be embodied in hardware or in firmware, or to a collection of software instructions, possibly having entry and exit points, written in a programming language, such as, for example, C++. A software module may be compiled and linked into an executable program, included in a dynamic link library, or may be written in an interpretive language such as BASIC. A software module or program may be in an executable state or referred to as an executable. An “executable” generally means that the program is able to operate on the computer system without the involvement of a computer language interpreter. The term “automatically” generally refers to an operation that performs without significant user intervention or with some limited user intervention. The term “launching” generally refers to initiating the operation of a computer module or program. As can be appreciated, software modules may be callable from other modules or from themselves, and/or may be invoked in response to detected events or interrupts. Software instructions may be embedded in firmware, such as an EPROM. Hardware modules may comprise connected logic units, such as gates and flip-flops, and/or may comprise programmable units, such as programmable gate arrays or processors.

The modules may be implemented in hardware, software, firmware, and/or a combination thereof. For example, as shown, the modules 230 may include an occupant monitoring system 232, a gaze tracker 234, and a learning engine 236. The learning engine 236 may include one or more of a detection module 242, a sentiment analyzer 244, and an occupant profiler 246.

The modules 230 may handle various interactions between the processing device 202 and other elements of the system 200 such as the autonomous vehicle controller 210 and the sensors 212 (including the imaging systems 212b, 212c). Further, the modules 230 may create data that can be stored by the memory 228. For example, the modules 230 may generate program data 250 such as profile records 252, which may include correlations 254 between driving aspects 256 and occupant parameters 258. The occupant parameters may include sentiments 262, biometrics 264, history 266, context 268, preferences 270, statistics 272, and the like.

The occupant monitoring system 232 may aid in gathering occupant data to detect and/or monitor occupant parameters 258. The learning engine 236 may process the occupant data and/or occupant parameters 258 to determine or identify suggested driving aspects 256 for communication to the autonomous vehicle via a vehicle interface (e.g., input/output interface 216) with the autonomous vehicle controller 210 of the autonomous vehicle.

The detection module 242 may process sensor data from one or more sensors 212 monitoring one or more occupant parameters to detect a potential hazard external to the autonomous vehicle. The detection is accomplished based on the occupant parameters 258.

The sentiment analyzer 244 processes occupant data and detects an occupant sentiment 262 toward current driving aspects 256, which the sentiment analyzer 244 records along with a correlation 254 of the occupant sentiment 262 and the driving aspects 256.

The occupant profiler 246 maintain an occupant profile that includes recorded correlations 254 of driving aspects 256 for the occupant and occupant parameters 258, including sentiments 262, biometrics 264, history 266, context 268, preferences 270, and statistics 272.

As explained earlier, sentiments 262 and biometrics 264 may be detected by the one or more sensors 212 (including the internal facing image capture system 212b) and the detection module 242. Biometrics 264, history 266, context 268, preferences 270, and statistics 272 may be obtained by the network interface 218.

The internal facing image capture system 212b is configured to capture image data of an occupant of a vehicle in which the system 200 is mounted and/or operable. The internal facing image capture system 212b may include one or more imagers or cameras to capture images of the operator. In certain embodiments, the internal facing image capture system 212b may include one or more array cameras. The image data captured by the internal facing image capture system 212b can be used to detect a reaction of an occupant to a potential external hazard, detect sentiment of an occupant, identify an occupant, detect a head/eye position of an occupant, and detect and/or track a current gaze of an occupant.

The external facing image capture system 212c captures image data of an environment in front of a vehicle. The external facing image capture system 212c may include one or more imagers or cameras to capture images of an area external to the vehicle, generally of an area in front of the vehicle, or ahead of the vehicle in a direction of travel of the vehicle. In certain embodiments, the external facing image capture system 212c may include one or more array cameras. The image data captured by the external facing image capture system 212c can be analyzed or otherwise used to identify objects in the environment around the vehicle (e.g., generally in front of the vehicle, or ahead of the vehicle in a direction of travel of the vehicle) to gather occupant data.

The gaze tracker 234 is configured to process occupant image data captured by the internal facing image capture system 212b to determine a line of sight of a current gaze of an occupant of the vehicle. The gaze tracker 234 may analyze the image data to detect eyes of the occupant and to detect a direction in which the eyes are focused. The gaze tracker 232 may continually process current occupant image data to detect and/or track the current gaze of the occupant. In certain embodiments, the gaze tracker 232 may process the occupant image data substantially in real time. The gaze tracker may include a pupil monitor to monitor pupil dilation. The pupil monitor may comprise a pupil tracker to process occupant image data of an occupant of the vehicle to determine a size of a pupil of the occupant.

Driving aspects 256 may include, but are not limited to, defensive actions such as slowing down, swerving, tightening seatbelts, closing windows, locking doors; unlocking doors, creating a greater distance (e.g., changing speed and/or direction), alerting authorities, altering driving route, altering a stopping distance (e.g., stronger braking for faster deceleration), audio alerts and signals (e.g., lights) to other vehicles, and activating emergency sensors (e.g., focusing a camera to follow user gaze) to determine potential hazards and provide additional information/feedback to the autonomous vehicle controller of the autonomous vehicle. Driving aspects 256 may also include an adjustment to one or more of velocity, acceleration, turn radius, and route of travel of the autonomous vehicle.

Each of the sentiments 262 stored in the memory 228 may be or otherwise represent a determination of an attitude of an occupant based on, for example, speech, biometrics, image processing, and live feedback. Classic sentiment analysis may analyze occupant sentiment toward current driving aspects through common text sentiment analysis methods while using speech-to-text and/or acoustic models to identify sentiment through tone of voice.

Biometrics 264 can be integrated into sentiment analysis, such as by capturing heart rate, blood pressure, and/or temperature of one or more occupants in order to understand levels of distress as a result of actual driving by the autonomous vehicle. For example, sudden changes in biometrics 264 may signal distress based on a current driving aspect. By contrast, biometric levels of an occupant upon entering the vehicle may be used to detect other sentiments. For example, biometric levels that, upon vehicle entry, are already raised above what may be normal or typical for the occupant may indicate stress, anxiety, or the like. Image processing can include emotion extraction methods to analyze occupant emotions, such as may be apparent from, for example, facial expression, actions, and the like. Live feedback mechanisms may be used to explore and/or confirm occupant likes and dislikes, detected sentiment, mood, preferences, and the like.

Driving history 266 may provide a representation of the way an occupant normally drives when controlling a vehicle. The way an occupant drives can be a strong indication to what type of driving experience the occupant would like to have with an autonomous vehicle. For example, someone who makes sharp turns or drives as fast as possible (according to the law) would expect the same. Someone who extends his or her driving paths to make sure or she he drives along the sea when possible would expect the same scenic routes taken by the autonomous car. The driving history 266 may be obtained from a training vehicle or during a training period of occupant operation of the autonomous vehicle.

Context 268 may include such information as occupant age, current medical situation, mood, and free time (e.g., according to a calendar or scheduling system), and may be important to determining suitable driving aspects. For example, an older person with heart problems may not appreciate, or even be adversely impacted by, an autonomous vehicle taking sharp turns or driving as fast as possible all the time. Similarly, tourists as occupants may desire a slightly longer route passing through significant or special landmarks.

Preferences 270 may be input by an occupant via a graphical user interface or a client computing device that can provide data to be accessible over a wireless network.

Statistics 272 may be collected by the autonomous vehicle, or acquired by a network access point, as described above. If a majority of vehicles (e.g., 90%) that pass through a given geographic sector follow similar driving aspects (e.g., speed, acceleration, turn radius, or the like), these statistics can inform the determination of suggested driving aspects for an autonomous vehicle.

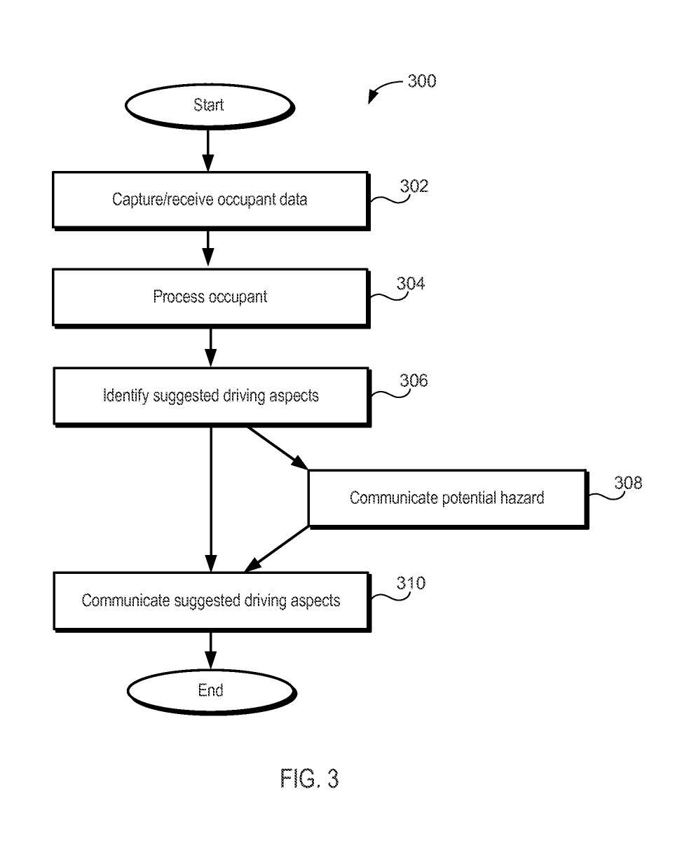

FIG. 3 is a flow diagram of a method 300 for control of an autonomous vehicle based on occupant parameters, according to one embodiment. Occupant data is captured or otherwise received 302, such as from sensors, a wireless network connection, and/or a stored profile. The occupant data may aid in identifying occupant parameters. The occupant data is processed 304 to identify 306 one or more suggested driving aspects based on the occupant data and/or occupant parameters. Alternatively, or in addition, a detected potential hazard may be communicated 308 to the autonomous vehicle. Processing the occupant data and/or parameters may include identifying an occupant reaction, such as to a potential hazard external to the vehicle, in order to detect that potential hazard and suggest 306 a driving aspect such as a defensive action to increase the safety of occupants.

Processing the occupant data and/or parameters may include detecting occupant sentiment toward current driving aspects and recording a correlation of the detected occupant sentiment and the current driving aspects in an occupant profile. The occupant data/parameters may be processed to identify 306 suggested driving aspects based on a correlation in an occupant profile that correlates an occupant sentiment and a driving aspect. The suggested driving aspects comprise one or more of a suggested velocity, a suggested acceleration, a suggested controlling of turns, and a suggested route of travel that may be to the occupant's liking, as determined for example based on the occupant sentiment.

### EXAMPLE EMBODIMENTS

Examples may include subject matter such as methods, means for performing acts of the methods, at least one machine-readable medium including instructions that, when performed by a machine cause the machine to performs acts of the methods, or an apparatus or system.

### Example 1

A safety system for an autonomous vehicle, the system comprising: an occupant monitoring system to monitor an occupant of the autonomous vehicle, the occupant monitoring system comprising one or more sensors to monitor one or more occupant parameters; a detection module to process sensor data received from the one or more sensors of the occupant monitoring system and to detect a potential hazard external to the autonomous vehicle based on the one or more occupant parameters; and a vehicle interface to communicate to the autonomous vehicle a detection of a potential hazard external to the autonomous vehicle, wherein the detection by the detection module is based on the one or more occupant parameters.

### Example 2

The system of Example 1, wherein the occupant monitoring system is configured to monitor a plurality of occupants of the autonomous vehicle.

### Example 3

The system of any of Examples 1-2, wherein the occupant monitoring system is configured to monitor an occupant positioned in a driver seat of the autonomous vehicle.

### Example 4

The system of any of Examples 1-3, wherein the occupant monitoring system is configured to monitor one or more occupant parameters indicative of an occupant reaction to a potential hazard external to the autonomous vehicle.

### Example 5

The system of Example 4, wherein the occupant monitoring system is configured to monitor one or more occupant parameters indicative of a human occupant response to a non-deterministic potential danger external to the autonomous vehicle.

### Example 6

The system of any of Examples 1-5, wherein the one or more occupant parameters include one or more of: sudden tensing or clenching of muscles; sudden movement of occupant backwards toward a seat back; twitching of at least one foot; use of language; eye movement; pupil dilation; head movement; heart rate; breath rhythm; and change in breath intake.

### Example 7

The system of any of Examples 1-6, wherein each sensor of the one or more sensors is to monitor an occupant parameter of the one or more occupant parameters.

### Example 8

The system of any of Examples 1-7, wherein the one or more sensors include one or more pressure sensors.

### Example 9

The system of Example 8, wherein the one or more pressure sensors are disposed on handles within a passenger compartment of the autonomous vehicle to detect the occupant tensing his or her hand muscles.

### Example 10

The system of Example 8, wherein the one or more pressure sensors are disposed within a seat of the autonomous vehicle to detect occupant movement relative to the seat, including a movement toward a back of the seat.

### Example 11

The system of Example 8, wherein the one or more pressure sensors are disposed on a floor of a passenger compartment of the autonomous vehicle to detect the occupant twitching at least one foot.

### Example 12

The system of Example 8, wherein the one or more pressure sensors are disposed within a seat of the autonomous vehicle to detect breath rhythm.

### Example 13

The system of any of Examples 1-12, wherein the one or more sensors include a microphone to detect the occupant using language.

### Example 14

The system of any of Examples 1-13, wherein the one or more sensors include a microphone to detect occupant language.

### Example 15

The system of any of Examples 1-14, wherein the one or more sensors include an eye movement tracker to monitor an eye movement parameter of the occupant, the eye movement tracker comprising: a gaze tracker to process occupant image data of the occupant of the autonomous vehicle to determine a current area of central vision of the occupant; and an internal facing image capture system to capture occupant image data of the occupant of the autonomous vehicle for processing by the gaze tracker.

### Example 16

The system of Example 15, wherein the gaze tracker is configured to determine a line of sight of a current gaze of the occupant of the autonomous vehicle, to determine a visual field of the occupant based on the line of sight of the current gaze of the occupant, and to determine the current area of central vision of the occupant within the visual field.

### Example 17

The system of Example 15, wherein the gaze tracker includes a pupil monitor to monitor pupil dilation, the pupil monitor comprising a pupil tracker to process occupant image data of an occupant of the vehicle to determine a size of a pupil of the occupant.

### Example 18

The system of any of Examples 1-17, wherein the vehicle interface communicates to a controller of the autonomous vehicle the detection of the potential hazard.

### Example 19

The system of any of Examples 1-8, wherein the vehicle interface communicates to the autonomous vehicle the detection of a potential hazard by providing suggested driving aspects, including a defensive action to increase safety of occupants of the autonomous vehicle.

### Example 20

The system of Example 19, wherein the defensive action to increase safety is one of: decreasing a velocity of travel of the autonomous vehicle; signaling with emergency lights; tightening safety belts; closing windows; locking doors; unlocking doors; increasing distance between the autonomous vehicle and vehicles in a vicinity of the autonomous vehicle; alerting authorities; altering driving route; altering stopping distance; audibly signaling; and activating one or more emergency sensors configured to detect potential hazards.

### Example 21

A method for controlling an autonomous vehicle, the method comprising: receiving occupant data for an occupant of the autonomous vehicle; processing occupant data received from the occupant monitoring system to identify one or more suggested driving aspects based on the occupant data; and communicating the one or more suggested driving aspects to the autonomous vehicle via a vehicle interface.

### Example 22

The method of Example 21, wherein the occupant data comprises one or more occupant parameters indicative of an occupant reaction to a potential hazard external to the autonomous vehicle wherein processing occupant data comprises detecting a potential hazard external to the autonomous vehicle based on the one or more occupant parameters of the occupant data, and wherein the one or more suggested driving aspects include a defensive action to increase safety of occupants of the autonomous vehicle.

### Example 23

The method of Example 22, wherein the one or more occupant parameters include one or more of: sudden tensing or clenching of muscles; sudden movement of occupant backwards toward a seat back; twitching of at least one foot; use of language; eye movement; pupil dilation; head movement; heart rate; breath rhythm; and change in breath intake.

### Example 24

The method of any of Examples 22-23, wherein the defensive action to increase safety is one of: decreasing a velocity of travel of the autonomous vehicle; signaling with emergency lights; tightening safety belts; closing windows; locking doors; unlocking doors; increasing distance between the autonomous vehicle and other vehicles in a vicinity of the autonomous vehicle; alerting authorities; altering a driving route; altering a stopping distance; audibly signaling; and activating one or more emergency sensors configured to detect potential hazards.

### Example 25

The method of any of Examples 21-24, further comprising identifying patterns of correlations of occupant data and driving aspects from which to identify the suggested driving aspects.

### Example 26

The method of any of Examples 21-25, wherein the occupant data comprises one or more of: historical driving aspects of driving by the occupant; contextual data; and occupant preference data.

### Example 27

The method of any of Examples 21-26, wherein processing the occupant data comprises: detecting occupant sentiment toward current driving aspects; and recording a correlation of the detected occupant sentiment and the current driving aspects in an occupant profile, wherein processing the occupant data to identify one or more suggested driving aspects includes identifying the one or more suggested driving aspects based on a correlation in the occupant profile that correlates an occupant sentiment and a correlated driving aspect.

### Example 28

The method of Example 27, wherein detecting occupant sentiment comprises collecting sensor from one or more sensors that detect and monitor one or more occupant parameters, wherein processing the occupant data includes identifying occupant sentiment based on the sensor data.

### Example 29

The method of any of Examples 21-28, wherein the suggested driving aspects comprise one or more of: a suggested velocity; a suggested acceleration; a suggested controlling of turns; and a suggested route of travel.

### Example 30

A non-transitory computer readable storage medium having stored thereon instructions that, when executed by a computing device, cause the computing device to perform the method of any of Examples 21-29.

### Example 31

A system comprising means to implement the method of any one of Examples 21-29.

### Example 32

A system for controlling an autonomous vehicle, the system comprising: an occupant monitoring system to obtain occupant data for an occupant of the autonomous vehicle; a learning engine to process occupant data received from the occupant monitoring system to identify one or more suggested driving aspects based on the occupant data; and a vehicle interface to communicate the one or more suggested driving aspects to the autonomous vehicle.

### Example 33

The system of Example 32, wherein the occupant monitoring system comprises one or more sensors to detect one or more occupant parameters indicative of an occupant reaction to a potential hazard external to the autonomous vehicle, wherein the learning engine processes sensor data from the one or more sensors of the occupant monitoring system to detect a potential hazard external to the autonomous vehicle based on the one or more occupant parameters, and wherein the one or more suggested driving aspects include a defensive action to increase safety of occupants of the autonomous vehicle.

### Example 34

The system of Example 33, wherein the one or more occupant parameters include one or more of: sudden tensing or clenching of muscles; sudden movement of occupant backwards toward a seat back; twitching of at least one foot; use of language; eye movement; pupil dilation; head movement; heart rate; breath rhythm; and change in breath intake.

### Example 35

The system of any of Examples 33-34, wherein the defensive action to increase safety is one of: decreasing a velocity of travel of the autonomous vehicle; signaling with emergency lights; tightening safety belts; closing windows; locking doors; unlocking doors; increasing distance between autonomous vehicle and vehicles in vicinity; alerting authorities; altering driving route; altering stopping distance; audibly signaling; and activating one or more emergency sensors configured to detect potential hazards.

### Example 36

The system of any of Examples 33-35, wherein each of the one or more sensors of the occupant monitoring system monitors an occupant parameter of the one or more occupant parameters.

### Example 37

The system of any of Examples 33-36, wherein the one or more sensors includes one or more pressure sensors.

### Example 38

The system of Example 37, wherein the one or more pressure sensors are disposed on handles within a passenger compartment of the autonomous vehicle to detect the occupant tensing his or her hand muscles.

### Example 39

The system of Example 37, wherein the one or more pressure sensors are disposed within a seat of the autonomous vehicle to detect occupant movement relative to the seat, including a movement toward a back of the seat.

### Example 40

The system of Example 37, wherein the one or more pressure sensors are disposed on a floor of a passenger compartment of the autonomous vehicle to detect the occupant twitching at least one foot.

### Example 41

The system of Example 37, wherein the one or more pressure sensors are disposed within a seat of the autonomous vehicle to detect breath rhythm.

### Example 42

The system of any of Examples 33-41, wherein the one or more sensors include a microphone to detect occupant language.

### Example 43

The system of any of Examples 33-42, wherein the one or more sensors include an eye movement tracker to monitor an eye movement parameter of the occupant, the eye movement tracker comprising: a gaze tracker to process occupant image data of the occupant of the autonomous vehicle to determine a current area of central vision of the occupant; and an internal facing image capture system to capture occupant image data of the occupant of the autonomous vehicle for processing by the gaze tracker.

### Example 44

The system of Example 43, wherein the gaze tracker is configured to determine a line of sight of a current gaze of the occupant of the autonomous vehicle, to determine a visual field of the occupant based on the line of sight of the current gaze of the occupant, and to determine the current area of central vision of the occupant within the visual field.

### Example 45

The system of any of Examples 33-44, wherein the one or more sensors include a pupil monitor to monitor pupil dilation, the pupil monitor comprising: a pupil tracker to process occupant image data of an occupant of the vehicle to determine a size of a pupil of the occupant; and an internal facing image capture system to capture occupant image data of the occupant of the vehicle for processing by the pupil tracker.

### Example 46

The system of any of Examples 32-45, wherein the vehicle interface communicates to a controller of the autonomous vehicle the one or more suggested driving aspects.

### Example 47

The system of any of Examples 32-46, the learning engine to receive occupant data and identify patterns of correlations of occupant data and driving aspects and record the patterns of correlation in a memory to identify the suggested driving aspects.

### Example 48

The system of Example 47, wherein the occupant data comprises historical driving aspects of driving by the occupant.

### Example 49

The system of any of Examples 47-48, wherein the occupant data comprises contextual data.

### Example 50

The system of Example 49, wherein the contextual data includes one or more of: occupant age; occupant health/medical information; occupant mood; and occupant schedule information.

### Example 51

The system of any of Examples 47-50, wherein the occupant data comprises occupant preference data.

### Example 52

The system of any of Examples 47-51, wherein the occupant monitoring system comprises a statistic system configured to gather statistical data for a given geographic sector, wherein the occupant data comprises statistical data.

### Example 53

The system of Example 52, wherein the statistical system gathers statistical data by forming a wireless data connection with a wireless network access point within the geographic sector.

### Example 54

The system of any of Examples 32-53, the learning engine comprising: a sentiment analyzer to process the occupant data and detect occupant sentiment toward current driving aspects, the sentiment analyzer recording a correlation of the detected occupant sentiment and the current driving aspects; and an occupant profiler to maintain an occupant profile that includes recorded correlations of an occupant sentiment and a driving aspect for the occupant, wherein the learning engine identifies the one or more suggested driving aspects based on a correlation in the occupant profile of an occupant sentiment and a correlated driving aspect.

### Example 55

The system of Example 54, the occupant monitoring system comprising one or more sensors to detect and monitor one or more occupant parameters, wherein the sentiment analyzer detects the occupant sentiment based on the sensor data from the occupant monitoring system.

### Example 56

The system of Example 55, wherein the one or more sensors comprise a microphone to capture occupant speech, wherein the sentiment analyzer detects the occupant sentiment based on the occupant speech.

### Example 57

The system of Example 56, wherein the sentiment analyzer detects the occupant sentiment using acoustic models to identify sentiment through tone of voice.

### Example 58

The system of Example 56, wherein the sentiment analyzer detects the occupant sentiment based on speech to text analysis.

### Example 59

The system of Example 55, wherein the one or more sensors comprise biometric sensors to capture biometric data for one or more of biometrics of the occupant, wherein the learning engine detects the occupant sentiment using the biometric data.

### Example 60

The system of Example 59, wherein the one or more biometrics of the occupant include one or more of: occupant heart rate; occupant blood pressure; and occupant temperature.

### Example 61

The system of any of Example 55-60, wherein the one or more sensors comprise imaging sensors to capture image data of the occupant, wherein the learning engine detects the occupant sentiment using the image data of the occupant.

### Example 62

The system of Example 54, wherein the sentiment analyzer comprises a feedback system to provide an opportunity for the occupant to express preferences, the feedback system configured to process commands of the occupant to obtain occupant expressed preferences and detect the occupant sentiment based on the expressed preferences.

### Example 63

The system of Example 62, wherein the feedback system is configured to process voice commands.

### Example 64

The system of Example 62, wherein the feedback system is configured to process commands provided via a graphical user interface.

### Example 65

The system of Example 54, wherein the suggested driving aspects comprise one or more of: a suggested velocity; a suggested acceleration; a suggested controlling of turns; and a suggested route of travel.

### Example 66

A safety method in an autonomous vehicle, the method comprising: receiving sensor data from one or more sensors of an occupant monitoring system that monitors one or more occupant parameters of an occupant of the autonomous vehicle; detecting a potential hazard external to the autonomous vehicle based on the one or more occupant parameters; and communicating detection of the potential hazard, via a vehicle interface, to a controller of the autonomous vehicle.

### Example 67

The method of Example 66, wherein communicating to the autonomous vehicle the detection of a potential hazard includes providing suggested driving aspects, including a defensive action to increase safety of the occupant of the autonomous vehicle.

### Example 68

The method of Example 67, wherein the defensive action to increase safety is one of: decreasing a velocity of travel of the autonomous vehicle; signaling with emergency lights; tightening safety belts; closing windows; locking doors; unlocking doors; increasing distance between the autonomous vehicle and other vehicles in a vicinity of the autonomous vehicle; alerting authorities; altering a driving route; altering a stopping distance; audibly signaling; and activating one or more emergency sensors configured to detect potential hazards.

### Example 69

A non-transitory computer readable storage medium having stored thereon instructions that, when executed by a computing device, cause the computing device to perform the method of any of Examples 66-68.

### Example 70

A system comprising means to implement the method of any one of Examples 66-68.

### Example 71

A system for suggesting driving aspects of an autonomous vehicle, the system comprising: an occupant monitoring system to monitor an occupant of the autonomous vehicle, the occupant monitoring system comprising one or more sensors to monitor one or more occupant parameters; a detection module to process sensor data received from the occupant monitoring system and to detect occupant sentiment pertaining to driving aspects of driving performed by the autonomous vehicle, wherein the detection module detects the occupant sentiment based on the one or more occupant parameters; a learning engine to receive detected occupant sentiment and driving aspects and determine correlations of occupant sentiments and driving aspects; an occupant profiler to maintain an occupant profile that includes correlations of occupant sentiments and driving aspects of driving performed in the autonomous vehicle; and a vehicle interface to communicate suggested driving aspects to the autonomous vehicle, based on a comparison of a current detected occupant sentiment and an occupant sentiment in the occupant profile.

### Example 72

The system of Example 71, wherein the one or more sensors includes one or more pressure sensors.

### Example 73

The system of Example 72, wherein the one or more pressure sensors are disposed on handles within a passenger compartment of the autonomous vehicle to detect the occupant tensing his or her hand muscles.

### Example 74

The system of Example 72, wherein the one or more pressure sensors are disposed within a seat of the autonomous vehicle to detect occupant movement relative to the seat, including a movement toward a back of the seat.

### Example 75

The system of Example 72, wherein the one or more pressure sensors are disposed on a floor of a passenger compartment of the autonomous vehicle to detect the occupant twitching at least one foot.

### Example 76

The system of Example 72, wherein the one or more pressure sensors are disposed within a seat of the autonomous vehicle to detect breath rhythm.

### Example 77

The system of any of Examples 71-76, wherein the one or more sensors include a microphone to detect occupant language.

### Example 78

The system any of Examples 71-77, wherein the occupant monitoring system comprises a statistic system configured to gather statistical data for a given geographic sector, wherein the detection module processes the statistical data.

### Example 79

The system of Example 78, wherein the statistical system gathers statistical data by forming a wireless data connection with a wireless network access point within the geographic sector.

### Example 80

The system of any of Examples 71-79, the learning engine comprising: a sentiment analyzer to process the occupant data and detect occupant sentiment toward current driving aspects, the sentiment analyzer recording a correlation of the detected occupant sentiment and the current driving aspects; and an occupant profiler to maintain an occupant profile that includes recorded correlations of occupant sentiments and driving aspects for the occupant, wherein the learning engine identifies the one or more suggested driving aspects based on a correlation in the occupant profile of an occupant sentiment and a correlated driving aspect.

### Example 81

An autonomous vehicle comprising: an occupant monitoring system to monitor an occupant of the autonomous vehicle, the occupant monitoring system comprising one or more sensors to monitor one or more occupant parameters; a detection module to process sensor data received from the one or more sensors of the occupant monitoring system and to detect a potential hazard external to the autonomous vehicle based on the one or more occupant parameters; and an autonomous vehicle controller to determine and cause the autonomous vehicle to execute a defensive action based on the detected potential hazard.

### Example 82

An autonomous vehicle comprising: an occupant monitoring system to obtain occupant data for an occupant of the autonomous vehicle; a learning engine to process occupant data received from the occupant monitoring system to identify one or more suggested driving aspects based on the occupant data; and an autonomous vehicle controller to provide autonomous navigation and control of the autonomous vehicle, wherein the autonomous vehicle controller receives the one or more suggested driving aspects and causes the autonomous vehicle to execute at least one of the one or more suggested driving aspects.

### Example 83

The autonomous vehicle of Example 82, wherein the occupant monitoring system comprises one or more sensors to detect one or more occupant parameters indicative of an occupant reaction to a potential hazard external to the autonomous vehicle, wherein the learning engine processes sensor data from the one or more sensors of the occupant monitoring system to detect a potential hazard external to the autonomous vehicle based on the one or more occupant parameters, and wherein the one or more suggested driving aspects include a defensive action to increase safety of occupants of the autonomous vehicle.

### Example 84

The autonomous vehicle of any of Examples 82-83, the learning engine comprising: a sentiment analyzer to process the occupant data and detect occupant sentiment toward current driving aspects, the sentiment analyzer recording a correlation of the detected occupant sentiment and the current driving aspects; and an occupant profiler to maintain an occupant profile that includes recorded correlations of occupant sentiments and driving aspects for the occupant, wherein the learning engine identifies the one or more suggested driving aspects based on a correlation in the occupant profile of an occupant sentiment and a correlated driving aspect.

### Example 85

The autonomous vehicle of Example 84, the occupant monitoring system comprising a detection module including one or more sensors to detect and monitor one or more occupant parameters, wherein the sentiment analyzer detects the occupant sentiment based on the sensor data from the occupant monitoring system.

The above description provides numerous specific details for a thorough understanding of the embodiments described herein. However, those of skill in the art will recognize that one or more of the specific details may be omitted, or other methods, components, or materials may be used. In some cases, operations are not shown or described in detail.

Furthermore, the described features, operations, or characteristics may be combined in any suitable manner in one or more embodiments. It will also be readily understood that the order of the steps or actions of the methods described in connection with the embodiments disclosed may be changed as would be apparent to those skilled in the art. Thus, any order in the drawings or Detailed Description is for illustrative purposes only and is not meant to imply a required order, unless specified to require an order.

Embodiments may include various steps, which may be embodied in machine-executable instructions to be executed by a general-purpose or special-purpose computer (or other electronic device). Alternatively, the steps may be performed by hardware components that include specific logic for performing the steps, or by a combination of hardware, software, and/or firmware.

Embodiments may also be provided as a computer program product including a computer-readable storage medium having stored instructions thereon that may be used to program a computer (or other electronic device) to perform processes described herein. The computer-readable storage medium may be non-transitory. The computer-readable storage medium may include, but is not limited to: hard drives, floppy diskettes, optical disks, CD-ROMs, DVD-ROMs, ROMs, RAMs, EPROMs, EEPROMs, magnetic or optical cards, solid-state memory devices, or other types of medium/machine-readable medium suitable for storing electronic instructions.

As used herein, a software module or component may include any type of computer instruction or computer-executable code located within a memory device and/or computer-readable storage medium. A software module may, for instance, comprise one or more physical or logical blocks of computer instructions, which may be organized as a routine, a program, an object, a component, a data structure, etc., that performs one or more tasks or implement particular abstract data types.

In certain embodiments, a particular software module may comprise disparate instructions stored in different locations of a memory device, which together implement the described functionality of the module. Indeed, a module may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

It will be obvious to those having skill in the art that many changes may be made to the details of the above-described embodiments without departing from the underlying principles of the invention. The scope of the present invention should, therefore, be determined only by the following claims.

We claim:

1. A safety system for an autonomous vehicle, the system comprising:
an occupant monitoring system to monitor an occupant of the autonomous vehicle, the occupant monitoring system comprising one or more sensors to monitor one or more occupant characteristics absent external sensor data;
a detection module to process sensor data received from the one or more sensors of the occupant monitoring system and to detect a potential hazard external to the autonomous vehicle based on the one or more occupant characteristics absent external sensor data; and
a vehicle interface to communicate to the autonomous vehicle a detection of a potential hazard external to the autonomous vehicle, wherein the detection by the detection module is based on the one or more occupant characteristics absent external sensor data.

2. The system of claim 1, wherein the occupant monitoring system is configured to monitor a plurality of occupants of the autonomous vehicle.

3. The system of claim 1, wherein the occupant monitoring system is configured to monitor an occupant positioned in a driver seat of the autonomous vehicle.

4. The system of claim 1, wherein the occupant monitoring system is configured to monitor one or more occupant characteristics indicative of an occupant reaction to a potential hazard external to the autonomous vehicle.

5. The system of claim 1, wherein each sensor of the one or more sensors is to monitor an occupant characteristic of the one or more occupant characteristics.

6. The system of claim 1, wherein the one or more sensors include one or more pressure sensors.

7. The system of claim 1, wherein the one or more sensors include a microphone to detect the occupant using language.

8. The system of claim 1, wherein the one or more sensors include a microphone to detect occupant language.

9. The system of claim 1, wherein the one or more sensors include an eye movement tracker to monitor an eye movement parameter of the occupant, the eye movement tracker comprising:
a gaze tracker to process occupant image data of the occupant of the autonomous vehicle to determine a current area of central vision of the occupant; and
an internal facing image capture system to capture occupant image data of the occupant of the autonomous vehicle for processing by the gaze tracker.

10. The system of claim 9, wherein the gaze tracker is configured to determine a line of sight of a current gaze of the occupant of the autonomous vehicle, to determine a visual field of the occupant based on the line of sight of the current gaze of the occupant, and to determine the current area of central vision of the occupant within the visual field.

11. The system of claim 1, wherein the vehicle interface communicates to a controller of the autonomous vehicle the detection of the potential hazard.

12. The system of claim 1, wherein the vehicle interface communicates to the autonomous vehicle the detection of a potential hazard by providing suggested driving aspects, including a defensive action to increase safety of occupants of the autonomous vehicle.

13. A method for controlling an autonomous vehicle, the method comprising:
receiving occupant data for an occupant of the autonomous vehicle absent external sensor data;
processing occupant data received from the occupant monitoring system to identify one or more suggested driving aspects based on the occupant data; and
communicating the one or more suggested driving aspects to the autonomous vehicle via a vehicle interface.

14. The method of claim 13, wherein the occupant data comprises one or more occupant characteristics indicative of an occupant reaction to a potential hazard external to the autonomous vehicle wherein processing occupant data comprises detecting a potential hazard external to the autonomous vehicle based on the one or more occupant characteristics of the occupant data, and
wherein the one or more suggested driving aspects include a defensive action to increase safety of occupants of the autonomous vehicle.

15. The method of claim 13, further comprising identifying patterns of correlations of occupant data and driving aspects from which to identify the suggested driving aspects.

16. The method of claim 13, wherein the occupant data comprises one or more of:
historical driving aspects of driving by the occupant;
contextual data; and
occupant preference data.

17. The method of claim 13, wherein processing the occupant data comprises:
detecting occupant sentiment toward current driving aspects; and
recording a correlation of the detected occupant sentiment and the current driving aspects in an occupant profile,
wherein processing the occupant data to identify one or more suggested driving aspects includes identifying the one or more suggested driving aspects based on a correlation in the occupant profile that correlates an occupant sentiment and a correlated driving aspect.

18. The method of claim 17, wherein detecting occupant sentiment comprises collecting sensor from one or more sensors that detect and monitor one or more occupant characteristics,
wherein processing the occupant data includes identifying occupant sentiment based on the sensor data.

19. The method of claim 13, wherein the suggested driving aspects comprise one or more of:
a suggested velocity;
a suggested acceleration;
a suggested controlling of turns; and
a suggested route of travel.

20. A non-transitory computer-readable storage medium having stored thereon instructions that, when executed by a computing device, cause the computing device to perform operations for controlling an autonomous vehicle, the operations comprising:
receiving occupant data for an occupant of the autonomous vehicle absent external sensor data;
processing occupant data received from the occupant monitoring system to identify one or more suggested driving aspects based on the occupant data; and
communicating the one or more suggested driving aspects to the autonomous vehicle via a vehicle interface.

21. The computer-readable storage medium of claim 20, wherein the occupant data comprises one or more occupant characteristics indicative of an occupant reaction to a potential hazard external to the autonomous vehicle
wherein processing occupant data comprises detecting a potential hazard external to the autonomous vehicle based on the one or more occupant characteristics of the occupant data, and
wherein the one or more suggested driving aspects include a defensive action to increase safety of occupants of the autonomous vehicle.

22. The computer-readable storage medium of claim 20, further comprising identifying patterns of correlations of occupant data and driving aspects from which to identify the suggested driving aspects.
